(19) United States
(12) Patent Application Publication
(10) Pub. No.: US 2004/0173510 A1
(43) Pub. Date: Sep. 9, 2004

(54) Back washing valve and filtering apparatus with the same

(76) Inventor: Bang Gyoon Jung, Gyeonggi-do (KR)

Correspondence Address: Albert Wai-Kit Chan, Law Offices of Albert Wai-Kit Chan, World Plaza Suite 604, 141-07 20th Avenue, Whitestone, NY, 11357, US

(21) Appl. No.: 10/483,821

(22) PCT Filed: Jul. 19, 2002
(86) PCT No.: PCT/KR02/01357

(30) Foreign Application Priority Data
Jul. 20, 2001 (KR) 2001-22095 U
Sep. 5, 2001 (KR) 2001-27204 U

(51) Int. Cl. B01D 21/24

(52) U.S. Cl. 210/108; 210/425; 210/427; 210/411

(57) ABSTRACT

A backwash valve controls or switch the direction of water flowing through a filter so as to filter foreign materials from water and/or automatically discharge foreigh materials previously filtered by the filter. The backwash valve comprises a body hollow in its inner space and a direction control unit movably mounted inside the body in such a manner as to be in close contact with the inner wall of the body. The backwash valve control or switch the flow of water which is automatically of manually introduced/discharged. Also, a backwash filtering device using the backwash valve can easily discharge foreign materials accumulated in the filter without replacing the filter with new one through operation of the backwash valve.

### TECHNICAL FIELD

The present invention relates to a filtering device, and more particularly, to a backwash valve and a filtering device using the same. In particular, the backwash valve of the invention can control or switch the direction of water flowing through a filter so as to filter foreign materials from water and/or automatically discharge foreign materials previously filtered by the filter.

### BACKGROUND ART

As well known in the art, a water purifier or filtering device receives water from the outside and clears foreign materials from water to produce purified water according to a desired use. The water purifier or filtering device flows water through a filter to produce water in use for drinking or recycling. Therefore, the performance of the filter has a great effect on the purifying ability of the water purifier or filtering device.

As the water purifier repeatedly purifies water, the filter thereof accumulates, for example, various foreign materials or impurities. Then it is required to replace the filter of the water purifier according to the quantity of impurities. If the filter is not replaced even though a considerable quantity of impurities are collected, the accumulated impurities degrade the performance of the filter and provide an atmosphere appropriate for the propagation of germs.

Accordingly, the water purifier of the prior art consumes a large amount of maintenance cost since it needs replacement of the filter for an adequate time period in order to normally exert its purifying ability. Further, replacement of the filter is also complicated and the replaced filter creates environmental pollution.

Also filters in use for devices for filtering water discharged from a swimming pool, public bath, aquafarm, aquarium, building and plant are replaced with new ones in a proper time in order to remove foreign materials accumulated thereon by filtering a predetermined amount of water. Otherwise foreign materials are removed from the filter on which foreign materials are accumulated.

For example, a filtering device equipped in the public bath utilizes a filter such as a net to filter waste water containing foreign materials such as hair, soap component and waste material from human bodies in order to recover heat energy contained in waste water which is discharged from the public bath. However, the filtering device requires a user to remove foreign materials accumulated on the filter via manual work, thereby causing inconvenience. Further, since foreign materials accumulated on the filter are removed via manual work, they may not be clearly removed from the filter, thereby creating breakdown in other valves.

### DISCLOSURE OF THE INVENTION

The present invention has been made to solve the foregoing problems and it is therefore an object of the present invention to provide a backwash valve and a filtering device using the same, which can control or switch the direction of water flowing through a filter so as to filter foreign materials from water and/or automatically discharge foreign materials previously filtered by the filter.

It is another object of the invention to provide a backwash valve and a filtering device using the same, which can control or switch the direction of water flowing through a filter by using a rotary direction control unit or reciprocating direction control unit so as to filter foreign materials from water and/or automatically discharge foreign materials previously filtered by the filter.

According to an aspect of the invention to obtain the above objects, it is provided a backwash valve comprising: a body hollow in its inner space; and a direction control unit movably mounted inside the body and closely contacted its outer surface with inner surface wall of the body, wherein the body includes: a first group of connecting ports formed in a first wall side along a longitudinal direction of the body; and a second group of connecting ports formed in a second wall side opposite to the first wall side with the first group of connecting ports formed therein to correspond to the first group of connecting ports; and wherein the direction control unit includes: a first section for allowing the first group of connecting ports to communicate with the second group of connecting ports in a first position; and a second section for allowing the first group of connecting ports to communicate with one another in a second position and the second group of connecting ports to communicate with one another in the second position.

According to another aspect of the invention to obtain the above objects, it is provided a filtering device using the backwash valve of the invention comprising: a filter for receiving raw water from a water source outside and filtering foreign materials therein; and a backwash valve for controlling or switching the flowing direction of the raw water into the filter from the water source, and for making the filter purify foreign materials contained in the raw water or automatically discharge the filtered foreign materials to the outside.

According to a further aspect of the invention to obtain the above objects, it is provided a filtering device using the backwash valve of the invention comprising: a filter for receiving first or second raw water from an outside and filtering foreign materials therein; and a backwash valve for controlling or switching the flowing direction of first and making the filter purify the first raw water and produce purified water or automatically discharge foreign materials from second raw water.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a block diagram of a water purifier of the invention;

FIG. 2A shows the construction of a rotary backwash valve shown in FIG. 1;

FIG. 2B is an enlarged view of a rotary direction control unit shown in FIG. 2A;

FIG. 3A shows the construction of the water purifier of the invention having a filtering process;

FIG. 3B shows the construction of the rotary backwash valve during operation of the water purifier as shown in FIG. 3A;

FIG. 4A shows the construction of the water purifier of the invention in the backwash operation;

FIG. 4B shows the construction of the rotary backwash valve in backwash operation of the water purifier as shown in FIG. 4A;

FIG. 5 shows the construction of a filtering device of the invention;

FIG. 6A shows the construction of a reciprocating backwash valve shown in FIG. 5;

FIG. 6B shows the construction of a reciprocating direction control unit in FIG. 6A;

FIG. 6C shows the cross-section along a line A-A in FIG. 6A;

FIG. 6D shows the cover of the reciprocating backwash valve in FIG. 6A;

FIG. 7A shows the construction of the filtering device of the invention having the filtering process;

FIG. 7B shows the construction of the reciprocating backwash valve in filtering process of the filtering device of the invention in FIG. 7A;

FIG. 8A shows the construction of the filtering device having a backwash operation;

FIG. 8B shows the construction of the reciprocating backwash valve in backwash operation of the filtering device of the invention in FIG. 8A;

FIG. 9 shows the construction of a filtering device in a public bath of the invention;

FIG. 10A shows the construction of the filtering device in the public bath of the invention having a filtering operation; and

FIG. 10B shows the construction of the filtering device in the public bath of the invention having a backwash operation.

### Best Mode for Carrying out the Invention

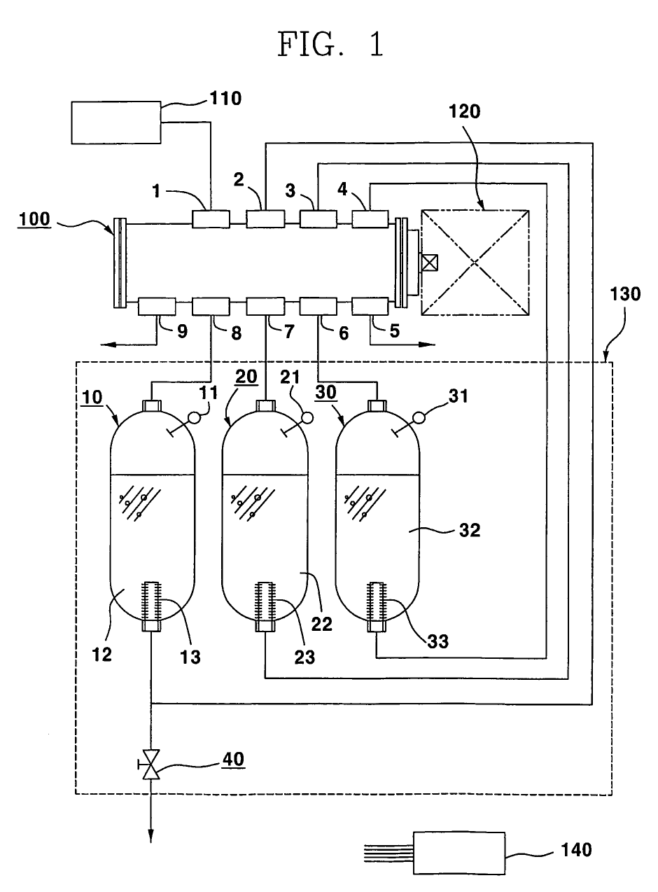

FIG. 1 is a block diagram of a water purifier of the invention. The water purifier includes: a rotary backwash valve 100 for receiving raw water fed from a water tank 110 storing raw water via a pipe, discharging received water after controlling or switching the direction the raw water and for receiving/discharging purified water or foreign materials; a power generating unit 120 attached to one end of the rotary backwash valve 100 for controlling the operation thereof; a filtering unit 130 for receiving the raw water from the rotary backwash valve 100 or semi-purified water, purifying the raw water or semi-purified water to produce final purified water and returning the final purified water to the rotary backwash valve 100, or for outputting foreign materials accumulated in a filtering process to the rotary backwash valve 100 by receiving the raw water from the rotary backwash valve 100; and a circuit unit 140 electrically connected to the above components for receiving detection signals therefrom and generating control signals for controlling the same.

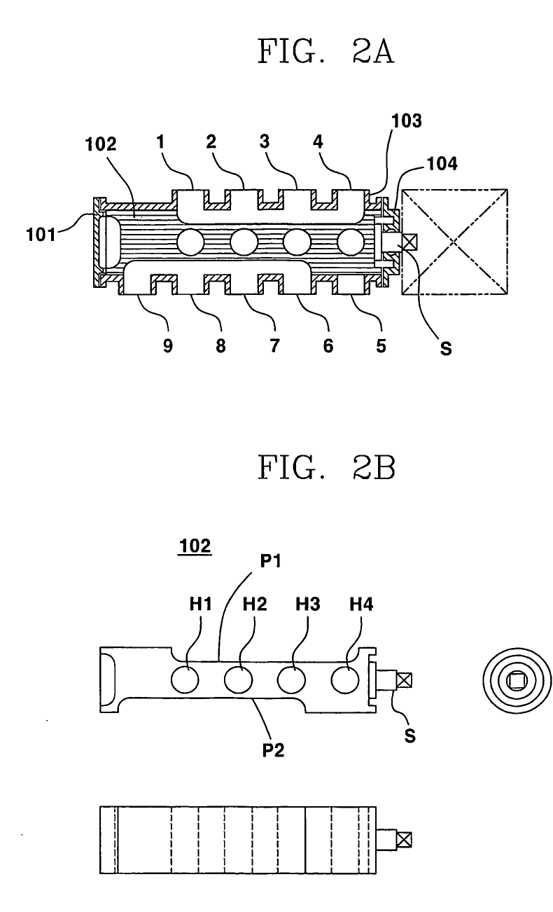

As shown in FIG. 2A, the rotary backwash valve 100 includes a cylindrical body 103 having first to fourth connecting ports 1 to 4 and fifth to ninth connecting ports 5 to 9 formed in both lateral portions thereof and having a rotary direction control unit 102 disposed therein, a first cover 101 for covering one end of the body 103 and a second cover 104 for covering the other end of the body 103 so that a shaft S of the rotary direction control unit 102 is projected from the second cover 102.

As shown in FIG. 2B, the rotary direction control unit 102 includes a first connecting plane P1 which is formed on one side of the control unit 102 by a predetermined depth to define a recess for allowing the first to fourth connecting ports 1 to 4 to communicate with each other in a predetermined first position, a second connecting plane P2 which is formed on the other side opposite to the first connecting plane P1 by a predetermined depth to define a recess for allowing the sixth to ninth connecting ports 6 to 9 to communicate with each other, a first hole H1 for allowing the first connecting port 1 to communicate with the eight connecting port 8 in the second position rotated at a proper angle, e.g. 90 deg., with respect to the first position, a second hole H2 for allowing the second connecting port 2 to communicate with the seventh connecting port 7 in the second position, a third hole H3 for allowing the third connecting port 3 to communicate with the sixth connecting port 6 in the second position for allowing the third connecting hole 3 to communicate with the sixth connecting hole 6, a fourth hole H4 for allowing the fourth connecting hole 4 to communicate with the fifth connecting hole 5 in the second position and a shaft S disposed at the other end of the body and connected to the power generating unit 120. In this case, the first to fourth holes H1 to H4 are formed in the body to be perpendicular to the first and second connecting planes P1 and P2.

The first connecting plane P1 has a length including or covering the first to fourth connecting ports 1 to 4 at a time and a width including or covering the diameter of one of the first to fourth connecting ports 1 to 4 and is formed by digging, by a predetermined depth, the outside surface of the rotary direction control unit 102 which is in close contact with the body to define a recess. Similarly, the second connecting plane P2 has a length including or covering the sixth to ninth connecting ports 6 to 9 at a time and a width including or covering the diameter of one of the sixth to ninth connecting ports 6 to 9, and is formed by a predetermined depth by digging, by a predetermined depth, the outside surface of the rotary direction control unit 102 which is in close contact with the body to define a recess.

The holes H1 to H4 are spaced apart from one another by a predetermined distance between the adjacent connecting ports and have a diameter similar to that of the connecting ports, thereby they are correspondingly placed the connecting ports. Also the axes of the holes are parallel to the first or second connecting plane.

The filtering unit 130 includes the first filter 10 for receiving raw water from the eighth connecting port 8 via the first connecting port 1 and the first hole H1 to produce first purified water and discharging the first purified water to the second connecting port 2, the second filter 20 for receiving the first purified water from the seventh connecting port 7 via the second connecting port 2 and the second hole H2 to produce second purified water and discharging the second purified water to the third connecting port 3, and the third filter 30 for receiving the second purified water from the sixth connecting port 6 via the third connecting port 3 and the third hole H to produce third purified water and discharging third purified water to the fourth connecting port 4. The first filter 10 includes a filtering material 12 made of sand, active carbon, elvan, natural jade and mixture thereof for purifying foreign materials from received water, an anti-discharge filter section 13 disposed within the filter 10 for preventing discharge of the filtering material in outputting purified water and a detector 11 for detecting the internal pressure of the filter 10 to determine the quantity of foreign materials accumulated therein and outputting a detection signal to the circuit unit 140. Similarly, the second and the third filters 20 and 30 include filtering material sections 22 and 32, anti-discharge filter sections 23 and 33 and detectors 21 and 31 which are similar in constructions and functions to the filtering material 12, the anti-discharge filter section 13 and the detector 11. In addition, the filtering unit 130 further includes a valve 40 for externally discharging the first purified water from the first filter 10.

The power generating unit 120 can be further embodied by a rotary motor with a shaft which can be rotated by a predetermined angle, e.g. 90 deg., under the control of the circuit unit 140 or a rotary rod which can be manually operated.

The detectors 11, 21 and 31 can be further embodied by a pressure detector capable of detecting the internal pressure of the first to third filters 10, 20 and 30.

When the rotary direction control unit of the rotary backwash valve is rotated by 90 deg. as shown in FIG. 2 in order to discharge the foreign materials accumulated in the filtering unit 130, raw water introduced via the first connecting port 1 flows through the filtering unit 130 reversely to a direction in which it flows during purification process, which is defined by ‘backwash process’ to be explained later. The operation of the water purifier of the present invention as constructed above will be described in reference to the accompanying drawings as follows:

1) Filtering Operation

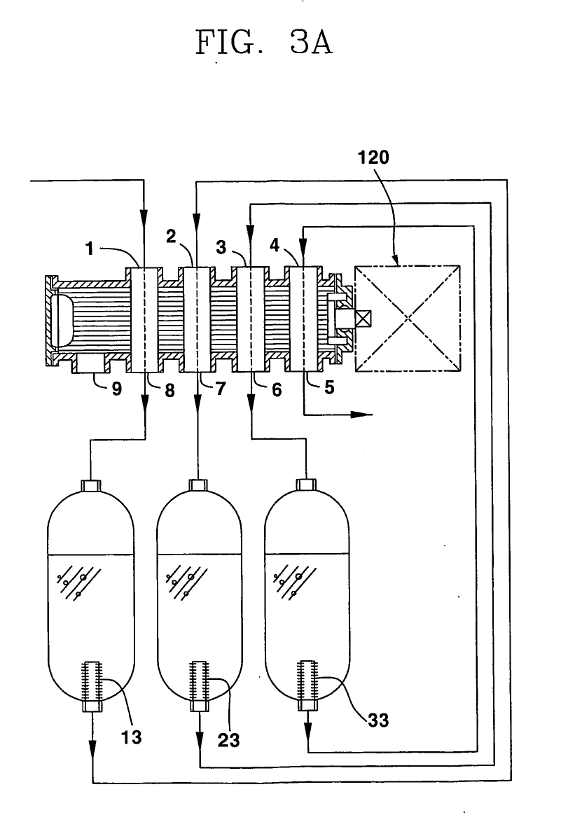

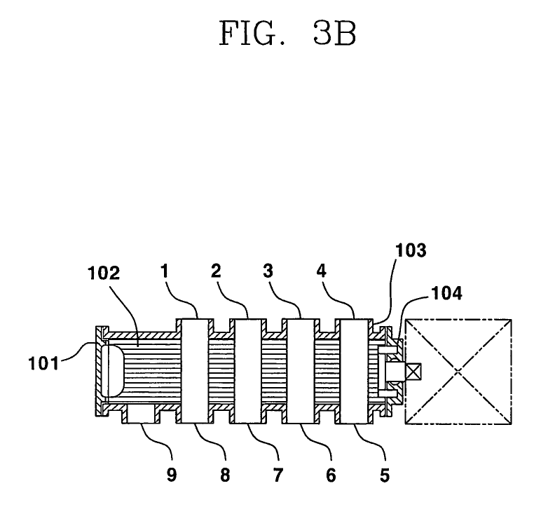

FIG. 3A is a block diagram of the filtering operation of the water purifier of the invention, and FIG. 3B shows the operating position of the rotary backwash valve during operation of the water purifier.

As shown in the drawings, when the filters 10, 20 and 30 purify raw water fed from the water tank 110 via the rotary backwash valve 100, the rotary direction control unit 102 of the rotary backwash valve 100 maintains its rotated position so that the first to fourth holes H1 to H4 connect the first to fourth connecting ports 1 to 4 and the eighth to fifth connecting ports 8 to 5, respectively, as shown in FIG. 3B. Then, as shown in FIG. 3A, the raw water fed from the water tank 110 enters the first filter 10 via the first connecting port 1 and then the eighth connecting port 8. The first filter 10 purifies the raw water to produce first purified water and then discharges the first purified water to the second connecting port 2. The first purified water is fed into the second purifier 20 via the second connecting port 2 and then discharges the seventh connecting port 7. The second purifier 20 purifies the first purified water to produce second purified water and then discharges the second purified water to the third connecting port 3. The second purified water is fed into the third filter 30 via the third connecting port 3 and then the sixth connecting port 6. The third filter 30 purifies the second purified water to produce third purified water, or final purified water, and discharges the final purified water to the fourth connecting port 4. Then, the final purified water is discharged via the fourth and fifth connecting ports 4 and 5 into a vessel desired by a user.

2) Backwash Operation

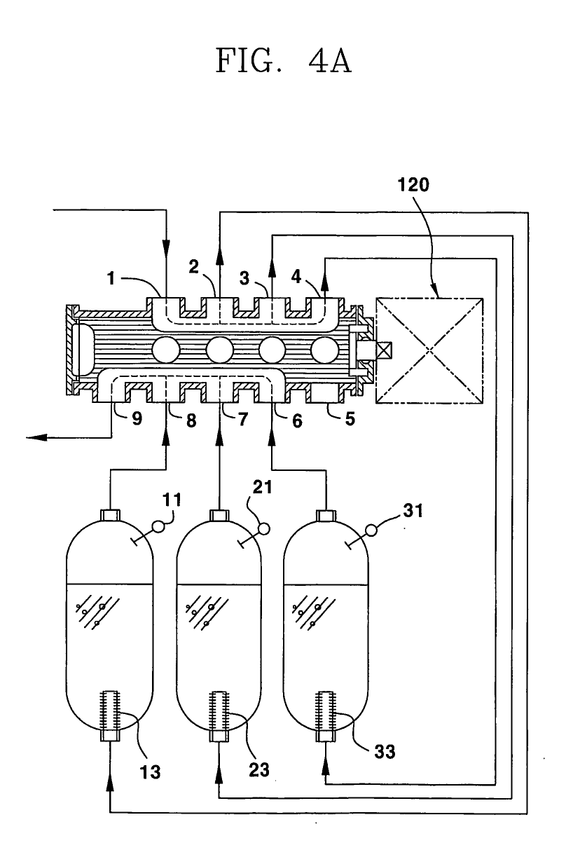

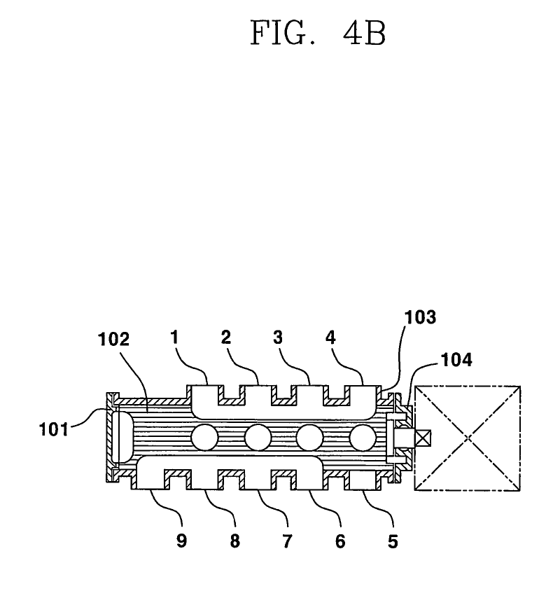

FIG. 4A is a block diagram of the backwash operation of the water purifier of the invention, and FIG. 4B shows the operating position of the rotary backwash valve in backwash operation of the water purifier.

While the water purifier purifies raw water, the first to third filters 10, 20 and 30 continuously filter the raw water and accumulate foreign materials therein within their inner spaces. The circuit unit 140 receives detection signals such as the internal pressures from the detectors 11, 21 and 31 installed in the filters 10, 20 and 30, respectively, and makes the water purifier carry out the backwash operation if the detection signals are larger than a predetermined reference value. When the water purifier executes the backwash operation, the rotary direction control unit 102 of the rotary backwash valve 100 is rotated under the control of the circuit unit 140, as shown in FIG. 4B. Namely, the first connecting plane P1 formed in the body of the rotary direction control unit 102 connects the first to fourth connecting ports 1 to 4 together and simultaneously the second connecting plane P2 connects the sixth to ninth connecting ports 6 to 9 together. Then, the raw water outputted from the water tank 110 is fed into the first connecting port 1 and discharged via the second to fourth connecting ports 2, 3 and 4 to the first to third filters 10, 20 and 30, as shown in FIG. 4A. The direction of water flowing from the second to fourth connecting ports 2, 3 and 4 to the first to third filters 10, 20 and 30 is opposite to that of the purified water produced by each of the water purifiers 10, 20 and 30.

Therefore, the raw water fed into the filters 10, 20 and 30 via each of the anti-discharge filter sections 13, 23 and 33 is discharged to the eighth to sixth connecting ports 8 to 6 containing foreign materials previously accumulated in the filters 10, 20 and 30 via the pipes through which raw water or intermediate purified water (i.e. first and second purified water) was introduced in purification operation of the filters 10, 20 and 30. Then, the rotary backwash valve externally discharges backwashed water containing the foreign materials inputted via the eighth to sixth connecting ports 8 to 6 to the ninth connecting port 9.

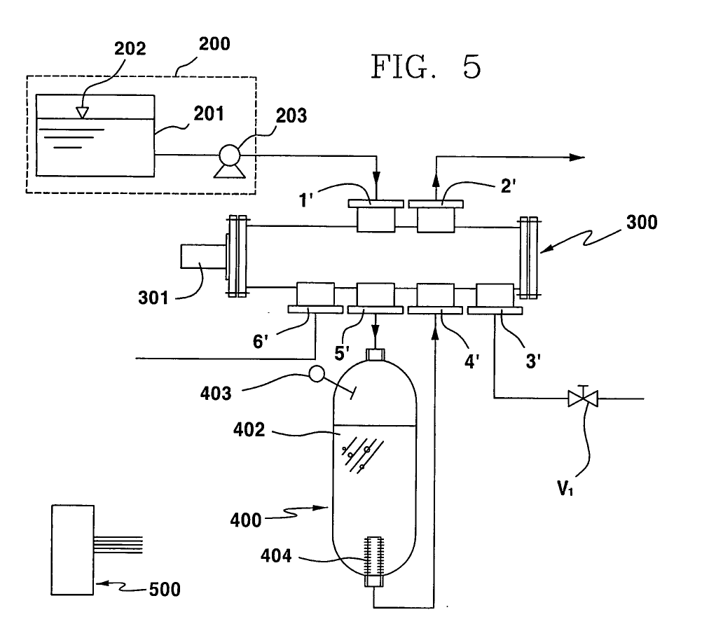

FIG. 5 is a block diagram of a filtering device of the invention. The filtering device includes a reciprocating backwash valve 300 for receiving waste water fed from a water storage unit 200 or raw water from a water source outside and for discharging purified water purified from waste water or discharging raw water together with foreign materials accumulated in the previously purified operation in a filtering unit 400 which will be explained later after controlling or switching the direction of the waste water or the raw water; a power generating unit 301 attached to one end of the backwash valve 300 to control the operation thereof; a filtering unit 400 for receiving waste water or raw water from the reciprocating backwash valve 300 to discharge purified water purified from waste water or raw water together with foreign materials accumulated in the backwash operation to the backwash valve 300, and a circuit unit 500 electrically connected to the above components for receiving detection signals from the components and generating control signals for controlling the same.

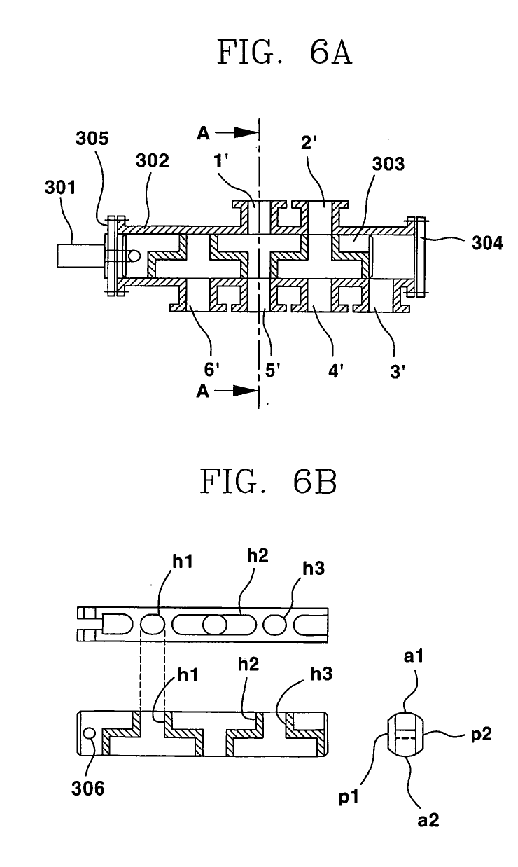

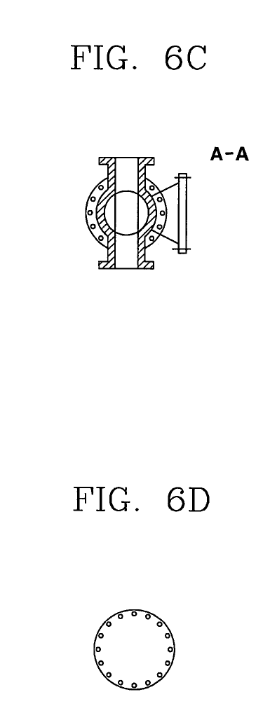

As shown in FIG. 6A, the reciprocating backwash valve 300 includes a body 302, first and second connecting ports 1′ and 2′ and third to sixth connecting ports 3′ to 6′ disposed at both sides of the body 302, and a reciprocating direction control unit 303 disposed within the body 302. The reciprocating backwash valve 300 also includes, as shown in FIG. 6D, a first cover 304 for covering one end of the body 302 and a second cover attached to the other end of the body 302, which has a connecting hole in its center so that the power generating unit 301 connects to the reciprocating direction control unit 303. The reciprocating backwash valve 300 is cylindrically manufactured as shown in FIG. 6C which is a sectional view taken along a line A-A in FIG. 6A.

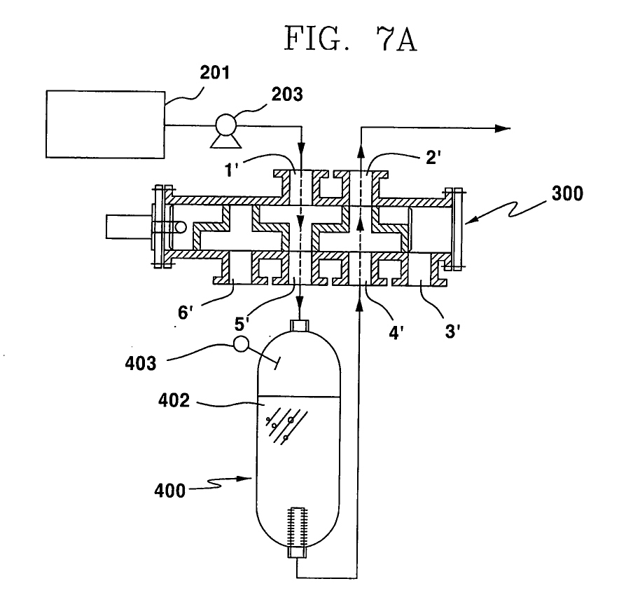

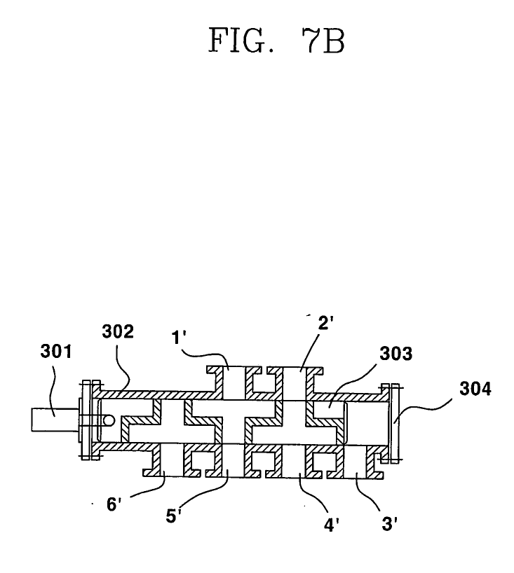

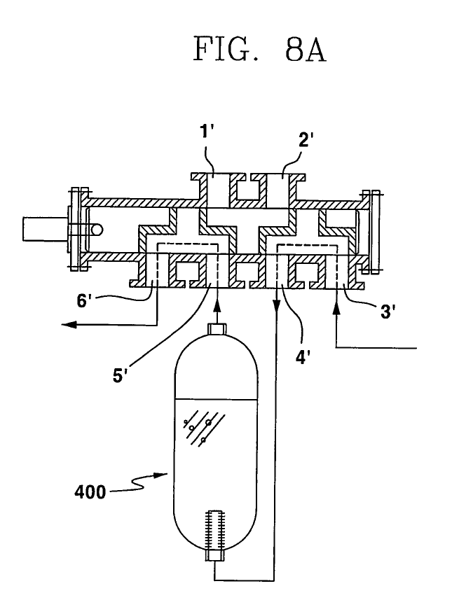

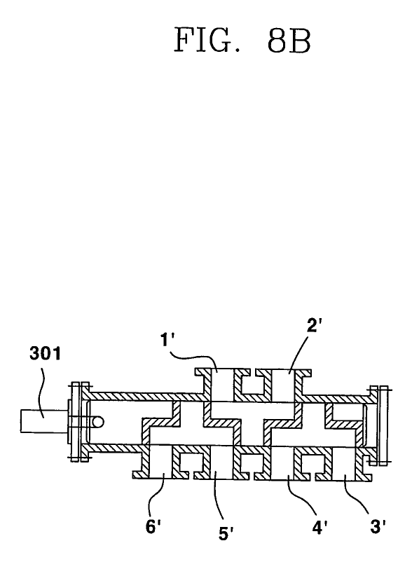

As shown in FIG. 6B, the reciprocating direction control unit 303 includes holes h1 and h3 which are formed in the same shape and aligned in the same direction therein, and a hole h2 formed between h1 and h3, which direction is up and down with respect to h1 and h3. One end of each hole has its hole size corresponding to that of the port 1′ or 2′ in case the hole h1 or h3 in a first position thereof, as shown in FIG. 7A, and corresponding to that of one of the port 3′, 4′, 5′, or 6′ in case that the hole 2 in the first position thereof. Also, the other end of each hole has its size to cover the ports 1′ and 2′ in case the hole h2 in a second position thereof, as shown in FIG. 8A, and to cover the ports 3′ or 4′ and 5′ or 6′ in case the holes h3 and h1 in the second position, respectively. The holes h1 to h3 have the symmetric form in the reciprocating direction control unit 303 at both sides thereof. The body of the reciprocating direction control unit 303 is manufactured so that surface a1 and a2 with the holes h1 to h3 have the same curvature as the inside wall of the reciprocating backwash valve 300 and other surfaces without the holes h1 to h3 are formed as planes p1 and p2. Here, between the planes p1 and p2 and the inside wall of the reciprocating backwash valve, a key groove (not shown) or a support for preventing rotation may be further formed. Also the reciprocating direction control unit 303 includes a connecting portion 306 at one end thereof connecting to the shaft of the power generating unit 301.

The reciprocating direction control unit moves along the longitudinal direction of the body by a distance substantially identical with the distance of the adjacent connecting ports to be maintained in the first or second position.

In the meantime, the holes h1 to h3 are shaped as Korean alphabets, ‘ [symbol] T’ which is pronounced as ‘woo’ or ‘⊥’ which is pronounced as ‘oh’ as shown in FIGS. 6A and 6B. That is, the holes h1 to h3 form to have a wide portion and a narrow portion adjacent to the wide portion. The wide portion has a length including distances between the connecting ports and a with similar to a sectional size of each of the first or second group of connecting ports, and is formed by digging, by a predetermined depth, the first or second group of connecting ports. The narrow portion is formed on another wall of the body from a central position (or the bottom) of the wide portion with a size substantially identical with that of the each connecting port.

The filtering unit 400 includes a filtering material 402, or a mixture made of materials such as sand, active carbon, elvan and natural jade, for purifying waste water from the fifth connecting port 5′ to produce purified water, an anti-discharge filter section 404 disposed within the filtering unit 400 for preventing discharge of the filtering material when outputting purified water and a detector 403 for detecting the internal pressure of the filtering unit 400 to determine the quantity of foreign materials accumulated therein and outputting a detection signal corresponding to the internal pressure to the circuit unit 500.

The power generating unit 301 can be embodied by one of an air or pneumatic pump capable of reciprocally shifting its shaft under the control of the circuit unit 500 or a rod which can be manually operated.

The detector 403 can be embodied by a pressure detector capable of detecting the internal pressure of the filtering unit 400.

The water storage unit 200 includes a water tank 201 for containing waste water, a water level detector 202 for detecting the water level of waste water contained in the water tank 201 and a pump 203 for forcibly discharging waste water from the water tank 201 into the reciprocating backwash valve 300.

Hereinafter the operating process of the filtering device of the invention as constructed above will be described in reference to the drawings as follows:

1) Filtering Operation

FIG. 7A shows the construction of the filtering device of the invention in filtering process, and FIG. 7B shows the construction of the reciprocating backwash valve in operation of the filtering device of the invention in FIG. 7A.

As shown in FIGS. 7A and 7B, when the filtering unit 400 purifies waste water fed from the water storage unit 200 via the reciprocating backwash valve 300, the reciprocating direction control unit 303 of the reciprocating backwash valve 300 maintains the first horizontal shift position so that the second and third holes h2 and h3 communicate with the first and second connecting holes 1′ and 2′ and the fifth and fourth connecting holes 5′ and 4′, respectively, as shown in FIG. 7B. Then, as shown in FIG. 7A, waste water fed from the water storage unit 200 enters the filtering unit 400 via the first connecting port 1′ and then the fifth connecting port 5′. The filtering unit 400 purifies the waste water to produce purified water and then discharges the produced purified water to the fourth connecting port 4′. Then, the reciprocating backwash valve 300 receives purified water via the fourth connecting port 4′ and discharges purified water via the second connecting port 2′ to the outside.

2) Backwash Operation

FIG. 8A shows the construction of the filtering device having a backwash operation, and FIG. 8B shows the construction of the reciprocating backwash valve in backwash operation of the filtering device of the invention in FIG. 8A.

As described above, the filtering unit 400 continuously filters foreign materials and accumulates the foreign materials therein while the filtering device carries out purification. The circuit unit 500 receives the detection signal converted from the internal pressure at the detector 403 installed in the filtering unit 400, and carried out backwash operation if the detection signal is larger than that of a predetermined value. That is, in order to execute the backwash operation, the reciprocating direction control unit 303 is in the second horizontal shift position as shown in FIG. 8B under the control of the circuit unit 500. Then the second hole h2 of the reciprocating direction control unit 303 connects the first connecting port 1′ with the second connecting port 2′, the third hole h3 connects the third connecting port 3′ with the fourth connecting port 4′, and the first hole h1 connects the fifth connecting port 5′ with the sixth connecting port 6′.

When the connecting ports communicate with one another as above, waste water is not introduced into the reciprocating backwash valve 300 while raw water is introduced into the third connecting port 3′. After introduced via the third connecting port 3′, the raw water is discharged via the third hole h3 to the fourth connecting port h4′ and then introduced into the filtering unit 400. After introduced into the filtering unit 400, the raw water is outputted to the fifth connecting port 5′ together with foreign materials previously accumulated in the filtering unit 400. Then, the raw water containing foreign materials introduced into the fifth connecting port 5′ is discharged to the sixth connecting port 6′ via the first hole h1 to the outside.

Therefore, the raw water is introduced into the filtering unit 400 in a direction opposite to that of water in which the filtering unit 400 purifies water, and then discharged with previously accumulated foreign materials to the outside.

The filtering device of the invention as constructed above is installed together with other facilities such as a swimming pool, public bath, aquafarm, aquarium, building and plant in order to purify water discharged therefrom.

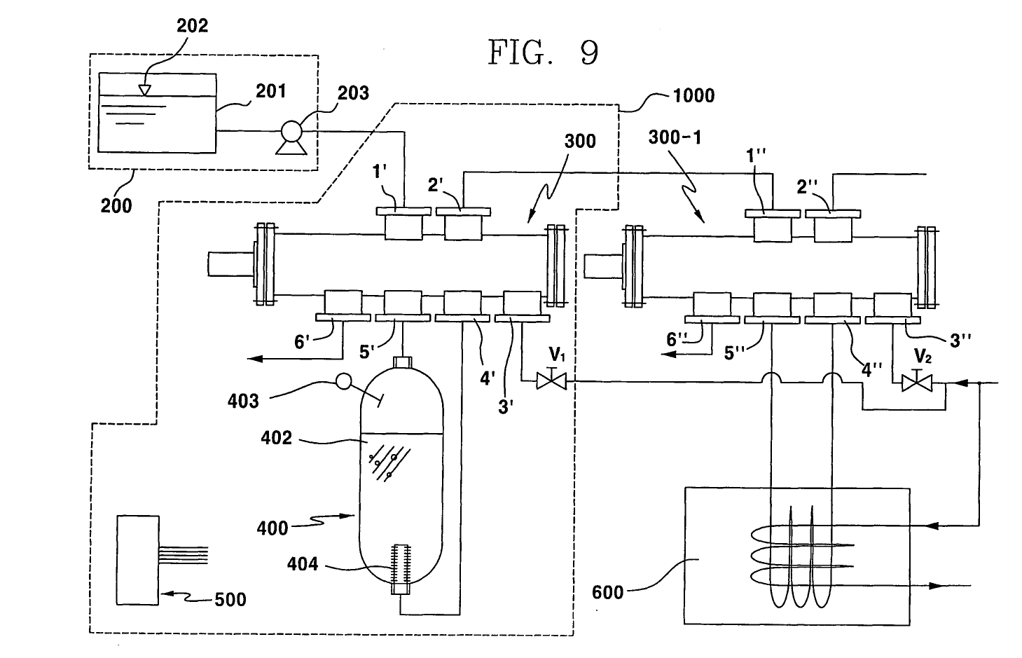

By way of example, as shown in FIG. 9, a filtering device 1000 equipped in a public bath is installed between a water storage unit 200 for containing waste water and a heater exchanger 600. As described above, when the filtering device 1000 purifies waste water from the water storage unit 200 and discharges the purified water to the heat exchanger 600, the heat exchanger 600 allows the purified water to indirectly contact raw water introduced from a water source outside so as to transfer heat contained in the purified water to the raw water.

As shown in FIG. 9, the heat exchanger 600 may be further provided with a first reciprocating backwash valve 300-1 like the backwash valve 300 which is installed in the filtering device 1000 in order to receive purified water which is discharged from the filtering device 1000 or raw water for backwashing scale and the like formed therein.

The filtering device 1000, the first reciprocating backwash valve 300-1 and the heat exchanger 600 are connected together as follows:

The second connecting port 2′ of the reciprocating backwash valve 300 of the filtering device 1000 is connected to the first connecting port 1″ of the first reciprocating backwash valve 300-1, and the second connecting port 2″ is connected to the outside or another backwash valve (not shown). The third connecting port 3″ is connected to a pipe for receiving raw water from a water source outside, the fourth and fifth connecting ports 4″ and 5″ are connected to the heat exchanger 600, and the sixth connecting port 6″ is connected to a pipe for discharging foreign materials such as scale formed in the heat exchanger 600 to the outside.

In the meantime, the heat exchanger 600 is connected to pipes for receiving and discharging raw water in order to transfer heat energy contained in purified water discharged from the first reciprocating backwash valve 300-1 to raw water which is introduced from the water source outside.

Also, the heat exchanger may be embodied by one of a tube-type or plate-type heat exchanger.

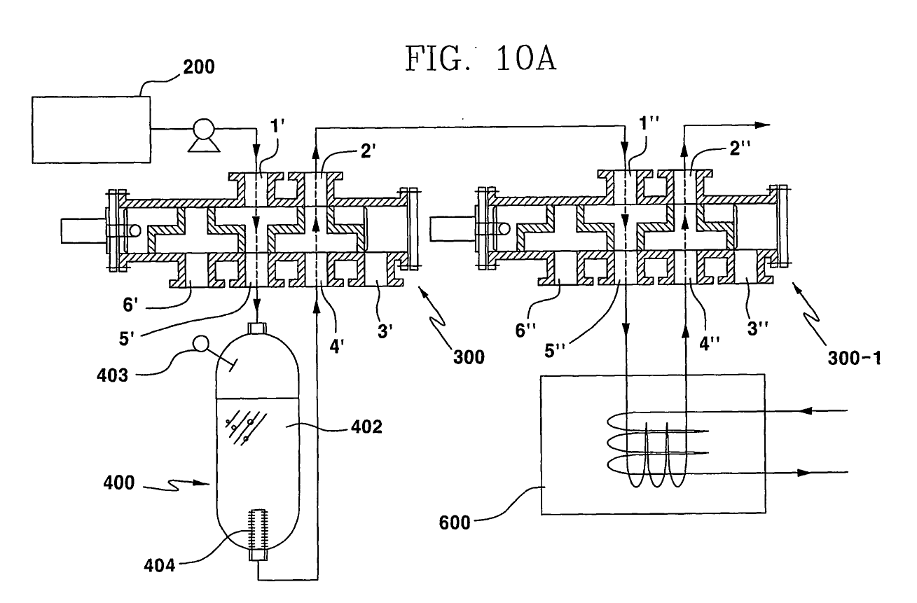

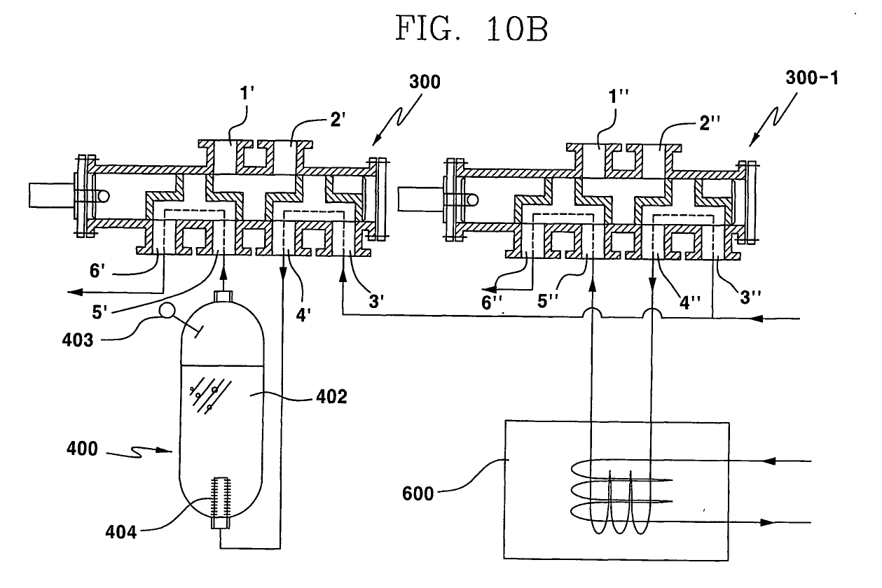

The filtering device in the public bath having the above construction carries out a filtering and backwash process as shown in FIGS. 10A and 10B.

1) Filtering and Heat Exchanging Process

When the filtering device in the public bath executes filtering and heat exchange, the backwash valves 300 and 300-1 installed in the filtering device and the heat exchanger maintain the position as shown in FIG. 7B. Then, as shown in FIG. 10A, waste water is treated into purified water by the filtering unit 400 while flowing through the components in the order of reference numbers such as 1′→5′→400→4′→2′. The purified water discharged from the second connecting port 2′ of the filtering device flows through the heat exchanger 600 via the components 1″ and then 5″ of the first reciprocating backwash valve 300-1 (1″→5″), and is discharged to the outside via the components 4″ and then 2″ of the first reciprocating backwash valve 300-1 (4″→2″). Therefore, the purified water transfer heat energy contained therein to the raw water.

2) Backwash Process

While the filtering device in the public bath carries out the filtering and heat exchange process, the filtering unit 400 continuously accumulates foreign materials therein. At the same time, fine scale is generated while purified water flows through the pipes and attached in the heat exchanger.

In order to backwash the foreign materials contained in the filtering device and the scale contained in the heat exchanger, the reciprocating backwash valves 300 and 300-1 installed in the filtering device and the heat exchanger maintain the position in FIG. 8B. As shown in FIG. 10B, the reciprocating backwash valve 300 of the filtering device and the first reciprocating backwash valve 300-1 of the heat exchanger introduce raw water to the third connecting ports 3′ and 3″ from the outside so that raw water flows in a direction opposite to that of water purification and a direction opposite to the flowing direction of purified water, respectively. The raw water containing scale and the like while flowing out through the heat exchanger is outwardly discharged via the sixth connecting port 6″ of the first reciprocating backwash valve 300-1, and the raw water containing foreign materialsas flowing out through the filtering unit 400 is discharged via the sixth connecting port 6′ of the reciprocating backwash valve 300.

### INDUSTRIAL APPLICABILITY

As described in detail as above, the backwash valve of the invention can control or switch automatically or manually the flow of water which is introduced/discharged thereto/from, and the backwash filtering device having the same can readily discharge foreign materials accumulated therein by operating the backwash valve, without replacement of the filters installed therein with new ones.

In the preferred embodiment as have been described above, the water purifier of the invention employs the three filters to purify raw water and dischare foreign materials. However, the filters can be varied in number according to the number of the connecting ports of the rotary backwash valves. Also the rotary backwash valves are arrayed in parallel or series so that the filters can purify raw water and foreign materials accumulated in the filters can be discharged therefrom.

Also, even though the filtering device of the invention has been described to have the single filter for discharging foreign materials therefrom, the filter can be varied in number according to the number of the connecting ports of the reciprocating backwash valve; the reciprocating backwash valves are arrayed in parallel or series so that the filters can purify raw water and foreign materials accumulated in the filters can be discharged therefrom.

Further, according to the embodiments of the invention, the rotary backwash valves and the reciprocating backwash valves are combined together to provide another filtering device.

1. A backwash valve comprising:
a body hollow in its inner space; and
a direction control unit movably mounted inside the body and closely contacted its outer surface with inner surface wall of the body,
wherein the body includes:
a first group of connecting ports formed in a first wall side along a longitudinal direction of the body; and
a second group of connecting ports formed in a second wall side opposite to the first wall side with the first group of connecting ports formed therein to correspond to the first group of connecting ports; and
wherein the direction control unit includes:
a first section for allowing the first group of connecting ports to communicate with the second group of connecting ports in a first position; and
a second section for allowing the first group of connecting ports to communicate with one another in a second position and the second group of connecting ports to communicate with one another in the second position.

2. The backwash valve as in claim 1, wherein the direction control unit is rotated within the body to be maintained in the first or second position.

3. The backwash valve as in claim 2, wherein the first section comprises planes each of which has a length corresponding to a sum of distances of the first group of connecting ports and the second group, of connecting ports, which has a width corresponding to a size of the first and second groups of connecting ports, and which is formed by digging, by a predetermined depth, an outside surface of the direction control unit in close contact with the inner wall of the body to define a recess.

4. The backwash valve as in claim 3, wherein the second section comprises holes neighboring on one another, spaced by a distance between the first or second group of connecting ports, having a size similar to a sectional size of each of the first and second connecting ports, and formed in parallel to the planes in the first section.

5. The backwash valve as in claim 2, wherein the second section comprises holes neighboring on one another, spaced by a distance between the first or second group of connecting ports, and having a size similar to a sectional size of each of the first and second connecting ports.

6. The backwash valve as in claim 1, wherein the direction control unit occupies the first or second position by shifting in a longitudinal direction of the body by a distance substantially identical with a distance between adjacent ones of the first or second connecting ports.

7. The backwash valve as in claim 6, wherein the first and second sections have a Korean alphabet shape, ‘ [symbol] T’, pronounce as ‘woo’, or ‘⊥’, pronounced as ‘oh’, and are adjacent to each other.

8. The backwash valve as in claim 6, wherein the first or second section comprises:
a wide portion having a length including distances between the first or second group of connecting ports and a width similar to a sectional size of each of the first or second group of connecting ports, and formed by digging, by a predetermined depth, the first or second group of connecting ports; and
a narrow portion adjacent to the wide portion, and formed into a wall of the body in close contact with the second or first group of connecting ports from a central position of the wide portion and having a size substantially identical with that of each of the first or second group of connecting ports.

9. A filtering device comprising:
a filter for receiving raw water from a water source outside and filtering foreign materials therein; and
a backwash valve for controlling or switching the flowing direction of the raw water into the filter from the water source, and for making the filter purify foreign materials contained in the raw water or automatically discharge the filtered foreign materials to the outside.

10. The filtering device as in claim 9, wherein the backwash valve comprises:
a body hollow in its inner space; and
a rotary direction control unit mounted inside the body, rotatable at its original position and closely contacted with its outer surface with inner surface wall of the body;
wherein the body includes:
a first group of connecting ports formed in a wall side along a longitudinal direction of the body, wherein the first group of connecting ports includes a first connecting port for introducing raw water and a second connecting port formed adjacent to the first connecting port for receiving filtered water from the filter; and
a second group of connecting ports formed in another wall side opposite to the wall side having the first group of connecting ports, wherein the second group of connecting ports includes a third connecting port opposed to the first connecting port, a fourth connecting port opposed to the second connecting port and a fifth connecting port for outwardly discharging foreign materials backwashed from the filter, and
wherein the rotary direction control unit includes:
a first section for allowing the first and third connecting ports to communicate with each other and allowing the second and fourth connecting ports to communicate with each other in the first rotation position, so that raw water introduced via the first connecting port is transferred to the filter via the third connecting port and purified water introduced from the filter via the second connecting port is discharged to the fourth connecting port; and
a second section for allowing the first and second connecting ports to communicate with each other and allowing the third, fourth and fifth connecting ports to communicate with one another in the second rotation position, so that the raw water discharged via the second connecting port is transferred to the filter and foreign materials from the filter are discharged via the fifth connecting port.

11. The filtering device as in claim 10, wherein the first section comprises planes each of which has a length corresponding to a sum of distances of the first group of connecting ports and the second group of connecting ports, which has a width corresponding to a size of the first and second groups of connecting ports, and which is formed by digging, by a predetermined depth, an outside surface of the direction control unit in close contact with the inner wall of the body to define a recess

12. The filtering device as in claim 10, wherein the second section comprises holes neighboring on one another, spaced by a distance between the first or second group of connecting ports, having a size similar to a sectional size of each of the first and second connecting ports, and formed in parallel to the planes in the first section.

13. The filtering device as in claim 10, wherein the body and the rotary direction control unit are provided in a manner that the first and second group of connecting ports are connected to corresponding first and second sections so that other groups of connecting ports and sections are adjacent to the body and the rotary direction control unit.

14. The filtering device as in claim 13, further comprising filters between the other groups of connecting ports and sections and in number corresponding to the same.

15. A filtering device comprising:
a filter for receiving first or second raw water from an outside and filtering foreign materials therein; and
a backwash valve for controlling or switching the flowing direction of first and making the filter purify the first raw water and produce purified water or automatically discharge foreign materials from second raw water.

16. The filtering device as in claim 15, wherein the backwash valve comprises:
a body hollow inner space; and
a reciprocating direction control unit movably mounted inside the body in a longitudinal direction thereof in such a manner as to be in close contact with a wall of the body,
wherein the body includes:
a first group of connecting ports formed in a wall side along a longitudinal direction of the body, wherein the first group of connecting ports includes a first connecting port for introducing first raw water and a second connecting port formed adjacent to the first connecting port for outwardly discharging filtered water which is introduced via the reciprocating direction control unit from the filter; and
a second group of connecting ports formed in another wall side opposite to the wall side having the first group of connecting ports, wherein the second group of connecting ports includes a third connecting port opposed to the first connecting port, a fourth connecting port opposed to the second connecting port, a fifth connecting port for introducing second raw water and a sixth connecting port for outwardly discharging foreign materials backwashed from the filter; and
wherein the reciprocating direction control unit includes:
sections, in the first position, for allowing the first and third connecting ports to communicate with each other and allowing the second and fourth connecting ports to communicate with each other, so that first raw water introduced via the first connecting port is transferred to the filter via the third connecting port and purified water introduced from the filter via the fourth connecting port is discharged to the second connecting port, and
in the second position, for allowing the fourth and fifth connecting ports to communicate with each other and allowing the third and fifth connecting ports to communicate with each other, so that second raw water introduced via the second connecting port is transferred to the filter and foreign materials from the filter are outwardly discharged via the sixth connecting port.

17. The filtering device as in claim 16, wherein the direction control unit occupies the first or second position by moving in a longitudinal direction of the body for a distance substantially identical with a distance between adjacent ones of the first or second connecting ports.

18. The filtering device as in claim 16, wherein the sections have a Korean alphabet shape, ‘ [symbol] ’, pronounce as ‘woo’, or ‘⊥’, pronounced as ‘oh’, and are adjacent to each other.

19. The filtering device as in claim 16, wherein the sections comprise:
a wide portion having a length including distances between the first or second group of connecting ports and a width similar to a sectional size of each of the first or second group of connecting ports, and formed by digging, by a predetermined depth, the first or second group of connecting ports; and
a narrow portion adjacent to the wide portion, and formed into a wall of the body in close contact with the second or first group of connecting ports from a central position of the wide portion and having a size substantially identical with that of each of the first or second group of connecting ports.
